(19) United States
(12) Patent Application Publication
(10) Pub. No.: US 2005/0178251 A1
(43) Pub. Date: Aug. 18, 2005

(54) Screw driver including a holding device

(75) Inventor: Martin Holland-Letz, Neustadt (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Felo-Werkzeugfabrik Holland-Letz GmbH, Neustadt (DE)

(21) Appl. No.: 11/059,446

(22) Filed: Feb. 16, 2005

(30) Foreign Application Priority Data
Feb. 16, 2004 (DE) 20 2004 002 440.3
Feb. 25, 2004 (DE) 10 2004 009 002.5
Mar. 5, 2004 (DE) 10 2004 010 794.7
Mar. 13, 2004 (DE) 10 2004 012 417.5
Jul. 21, 2004 (DE) 10 2004 035 384.0
Jul. 30, 2004 (DE) 10 2004 037 429.5

(51) Int. Cl. B25B 13/00

(52) U.S. Cl. 81/438

(57) ABSTRACT

A screw driver (50) for use with electrical appliances under voltage includes a handle (1) and a functional part (2) with a shank (3) and an end piece (5). The shank (3) is designed to be partly covered by an insulating sleeve (9) made of plastic. The end piece (5) is insulated and connectable to said handle (1) so that torque is transferable from said handle (1) to said functional part (2). The handle (1) is insulated from said shank (3). Furthermore the screw driver (50) includes a holding device (11) which is connected to the handle (1) and comprises a secured position and a released position. The holding device (11) is manually operable between the secured position and the released position. In the secured position the holding device (11) positively engages the functional part (2) such that the functional part (2) cannot be detached from the handle (1). In the released position the functional part (2) is allowed to be detached from said handle (1).

### CLAIM FOR PRIORITY

This application claims priority to co-pending German “Gebrauchsmuster” DE 20 2004 002 440.3 filed Feb. 16, 2004, German Patent Application No. DE 10 2004 009 002.5 filed Feb. 25, 2004, German Patent Application No. DE 10 2004 010 794.7 filed Mar. 05, 2004, German Patent Application No. DE 10 2004 012 417.5 filed Mar. 13, 2004, German Patent Application No. DE 10 2004 035 384.0 filed Jul. 21, 2004, and German Patent Application No. DE 10 2004 037 429.5 filed Jul. 30, 2004, these being incorporated in their entireties herein by this reference.

### FIELD OF THE INVENTION

The present invention generally relates to a screw driver suitable for use with electrical appliances under voltage. The screw driver comprises a handle and a functional part which is removably inserted in the handle. A screw driver set can be built with only one handle and a plurality of functional parts. The functional parts especially comprise blades of screw drivers with different kinds of tips configured to fit in different screw sizes and types, for example slotted, Phillips®, Pozidrive® and Torx® profile screws. The functional parts may also comprise nutdrivers.

### BACKGROUND OF THE INVENTION

From prior art different types of screw drivers are known:
a) Screw drivers comprising a handle with a fixed shank or blade.
b) Screw drivers with a handle comprising a cavity. A functional part or shank is inserted to the cavity positively engaging the handle in a circumferential direction. A detachable connection between handle and functional part provides the possibility of using the same handle with different types of functional parts and tips (cf. German Patent Application DE 1 242 520) and the assembly of screw driver sets that are usually packed in a box.
c) Special screw drivers with a small lateral extension, mainly comprising a shank without a handle but with a swivel cap rotatably connected with the rear end of the shank. The cap is loaded by thrust forces by the user of the screw driver in order to press the tip of the functional part against a screw.
d) Screw drivers with a shank being partly covered by an insulating sleeve made of plastic for use with electrical appliances (cf. German “Gebrauchsmuster” DE-GM 7 135 254).
e) Screw drivers with a core or shank made of metal wherein the front end of the shank comprises a carrier for bits with different tips.

A screw driver with a shaft surrounded by a core is known from German Patent Application DE 44 01 335 A1. The core is frictionally engaged, but non-detachably connected with the handle of the screw driver. The core has a non-circular cross-section in order to transmit torque. In its end region the core is provided with slots, so that it is possible to insert the core into the cavity of the handle similar to a plaque or peg. According to a special embodiment of this patent application, the core is positively engaging the handle by means of a detachable snap connection so that a screw driver is built with a handle and an interchangeable shank. Furthermore, the aforementioned publication mentions an electric insulation according to German regulations (VDE-rules). For such an insulation, the core is extruded on the shaft both in the region inserted in the handle and the region between the handle and the functional tip in order to avoid electric current between the shank and the handle. The handle is made of plastic by injection moulding.

A pocket-screw driver is known from German “Gebrauchsmuster” DE-GM 1 861 500. The shank is movable with respect to the handle. In an operating position of the shank a holding element connected to the handle positively engages a groove of the shank so that the shank is locked in the handle. The positive engagement between holding element and groove is disengaged by means of a push button operated manually in radial direction.

A screw driver set is known from the company Vessel Co., Thailand (trademark “FAMIDORA EIGHT”, number TD 800, barcode No. 4 907 587 061300). The set comprises a plurality of functional parts with different tips being interchangeably insertable in one single handle. The functional parts comprise an end piece made of plastic having a uniform non-circular cross-section that positively engages the handle in a circumferential direction in order to transmit torque between the handle and the functional part. In the operating position, an elastic radial protrusion of the handle engages a corresponding groove or notch of the end piece. To remove the functional part from the handle, a user can apply an axial force sufficient to produce a radial elastic deformation of the protrusion to lead to a disengagement between the protrusion and the groove so that the functional part can be removed from the handle.

From a catalogue of the company WERA “WERA—Der Schraubwerkzeugkatalog”, edition 1993, pages 26-29 and 38-43 a screw driver is known with a handle built integrally with the insulation of the shank. The insulation and the handle are extruded in its entirety in one production step and without any seam.

Further examples of the connection between a shank and a handle or a holding device can be found in patents and patent applications DE 102 19 418 A1, WO 98/38012, U.S. Pat. No. 6,363,820 B1, U.S. 2002/0170394 A1, U.S. Pat. No. 1,473,186 and U.S. Pat. No. 5,957,014.

### SUMMARY OF THE INVENTION

The present invention relates to a screw driver with a handle and an interchangeable functional part. A detachable connection between the functional part and the handle provides the possibility of two differing operational modes:
In a first mode, the functional part can be used without any handle for applying torque to a screw. In this mode, the lateral dimension of the region of the functional part for holding and applying torque is relatively small due to the fact that a handle with a relatively large cross-section is not used. Accordingly, the tool can be deployed also for an assembly wherein the screws are only accessible through small slots or holes. In this operational mode, the functional part is especially adapted for sensitive work requiring exact or small amounts of torque.
In a second operational mode, the outer diameter of the tool can be increased by connection of the functional part with the handle so that increased torques can be produced with the same forces applied by the user of the screw driver. The outer shape of the handle can be shaped such that an improved haptic is provided. Further improvements can be gained by choice of the materials and the characteristic mechanical properties of the handle.

Because of the interchangeability of different functional parts the same handle can be used with different functional parts for different screws.

According to the invention, the functional part comprises an end piece which supports or effects the connection between the functional part and the handle. In the case where the end piece is made of a material different than the blade or the shank, these components can be built separately, made of different materials and can be machined and processed in different ways: according to one embodiment, the shank or blade is made of metal and finished for yielding a shank with high strength, wherein the material for the end piece has been chosen on the basis of criteria as interchangeability, low weight, appropriate contact surfaces and insulating properties.

The present invention provides the possibility that a set of functional parts with tips for a plurality of screws of different sizes and types and of one handle can be located in a relatively small box so that the mechanic does not have to carry abroad a plurality of screw drivers each comprising an uninterchangeable functional part, which would lead to increased weight and bulky dimensions.

The screw driver may comprise a holding device. In an operational position the functional part is positioned inside the handle so that torque can be transmitted. In such an operational position, the holding device comprises two different states:
In a secured position, the functional part is secured at least in one axial direction with respect to the handle, so that the functional part cannot be detached from the handle. In this secured position the screw driver can be used to apply torque to a screw or nut.
Additionally, the holding device comprises a released position such that the functional part is allowed to be detached from the handle. The detachment of the functional part can be provided by a rotational or translational relative movement between the functional part and the handle.

By means of the holding device an accidental detachment of the functional part is avoided, which could bear the risk that the functional part could drop down. Furthermore, an unintentional movement of the functional part out of the operational position is avoided. If torque is applied to the screw driver with the functional part not being in the operational position, the contact surfaces between the handle and the functional part could be damaged.

The holding device can be moved by manual operation of the user from the secured position to the released position. The manual operation can be effected by means of an actuation element, which is pushed by a finger or the hand of the user.

The screw driver according to the invention can be adapted for use with electrical appliances under voltage. The functional part is partly or completely (except the functional tip) covered by an insulating sleeve and the end piece. The inventor has realized that screw drivers known from prior art with interchangeable functional parts are not suitable for safe electrical appliances under voltage even if the shank or blade in those embodiments known from prior art is covered by an insulating sleeve of plastic. For a secure transmission of the torques, the handle made of plastic often comprises an inner casing. The functional parts made of steel are inserted in positive engagement into the casing. The tip of the shank, which in other areas is completely covered by an insulating sleeve of plastic, has to remain without a sleeve insofar as a sleeve made of plastic could be damaged in the contact area between the tip and the screw as a result of the applied torques and applied thrust forces encountered there. In other known embodiments, the casing inside the handle made of metal does not exist. Instead, the rear end of the shank extends far inside the handle in order to provide a large contact area for a transmission of torque and in order to lower the surface pressure in the contact area.

According to the specification EN 60900 for hand tools for use with electrical appliances under voltage, all tools must be tested by being dipped into a water bath up to the functional tip and exposed to a voltage of 10,000 volts. A screw driver comprising a casing inside the handle and extending far into the handle with an insulating sleeve covering the functional part except the functional tip would not pass the necessary test for a sufficient insulation because water could soak into the casing or cavity. The water could build an electrical connection between the functional tip and another end of the shank which is not insulated so that in the test set up, a closed circuit could be built leading to undesired tracking currents so that the tested screw driver would not pass the test.

The present invention avoids the aforementioned drawbacks by covering the shank with an insulating sleeve and an insulating end piece so that a transmission of electrical voltage between the shank and the handle to the user of the screw driver is avoided.

According to another embodiment of the invention, special attention is drawn to the holding device in order to avoid an electrical bridge between the handle and the shank by means of the holding device. The inventor has discovered that it is not sufficient if the holding device acts upon the shank or blade or on a torque transmitting surface, in particular upon a component made of metal. The invention provides the holding device acting upon the insulating sleeve and/or the end piece, so upon an outer surface of the insulating sleeve or end piece that could be made of plastic. According to the invention, it is also possible that the insulating sleeve and/or the end piece is built of a plurality of materials, different plastics or of a composite material. In these embodiments, an inner material is responsible for an insulation whereas another material positioned at the outer surface is adapted for cooperation with the holding device. Alternatively, it is also possible that the holding device does not act upon an insulated area of the functional part. Instead, the holding device itself is built for being an insulator or could be made of plastic so that the holding device avoids an electrical bridge between the user and the shank.

Due to the construction of the holding device and the choice of materials (in particular plastics) for the holding device, the insulating sleeve and/or the end piece fulfills the requirements of the specification EN 60900 of tools assembled of multiple parts:

Changes of the temperature in the region between −20° C. and +70° C. do not interfere with the functional capacity of the screw driver. Moreover, the aforementioned specification requires that the screw drivers composed of multiple parts comprise a holding device that is secured with respect to an unintentional detachment of its components. Here, the inventor has discovered that snapping connections are not suitable for fulfilling these requirements. For low temperatures, insertion and detachment of the functional part in the snapping connection leads to tensions causing cracks or fissures, in particular of elastic parts of the snapping connection. These cracks or fissures lower the insulating capacity and decrease the operational safety of the screw driver. Another requirement of the aforementioned specification is that tools comprising a positively-engaging connection must be tested on the basis of a force of 500 N acting in a direction for a detachment of the components. Snapping connections bear the risk that the securing force depends upon the temperature so that for high temperatures, the tool fails in the tests.

According to another aspect of the invention, the actuating element of the holding device is moved by the user in a radial direction of the handle in order to move the holding device from its secured position to its released position. This embodiment is advantageous in that a radial movement of the actuation element, in particular a radial movement of a thumb, is easy to effect by the user, if the handle is positioned in the hand of the user. If the hand of the user surrounds a large area of the outer surface of the handle and the user wants to apply large torques to the handle, an unintentional activation of the actuation element in radial direction with a displacement sufficient for moving the holding device to the released position does not occur so that an unintentional detachment of the functional part is impossible. This effect can be strengthened by an appropriate choice of the position of the holding device, wherein according to a special embodiment the holding device is positioned near the front end of the handle.

Moreover, the inventor has discovered that a radial movement of the actuation element is easy to transform to a movement of a holding element suitable to provide holding or coupling between the handle, the holding device and the functional part:
By means of the radial movement, radial contact forces can be produced between the handle, the functional part and the holding device so that a frictional engagement between the handle and the functional part is caused.
Additionally or alternatively, during a radial movement, a holding element could engage in the radial direction with a suitable radial recess or protrusion creating a positive engagement between handle and functional part. Such a positive engagement leads to the advantage that also for small activation forces of the actuation element large holding forces can be provided in one single or both axial directions of the functional part.

Alternatively or additionally, it is also possible that the actuation element is moved in a circumferential direction, in particular to provide or detach a lock.

The screw driver may comprise a spring element. For manual actuation of the actuation element in the released position of the holding device, the spring element is at least partly compressed. Without the actuation force of the user, the spring element automatically decompresses itself, moves the actuation element back and moves the holding device from the released position to the secured position. This facilitates the use of the screw driver during an interchange of different functional parts because the user only for a detachment of a functional part needs to apply forces upon the actuation element. At the same time, the spring element secures the actuation element in the secured position of the holding device, if the actuation element is free of external forces.

According to another embodiment of the invention, the holding device comprises a holding element which is in corporation with the actuation element. The holding element could be built integrally with the actuation element or could be coupled to the actuation element by a drive connection, a transmission or a lever.

The holding device may comprise a carrier with a lower part which could build the holding element, and an upper part cooperating with or constituting the actuation element. The upper part and the lower part are positioned on opposing sides of the functional part and connected by a side element of the carrier. By use of the carrier, a radial movement of the actuation element inside can be changed to a movement of the holding element away from the functional part. Due to such a “change of the directions of motion,” the carrier is a very simple solution for providing a way to release the functional part from the handle by radially pushing the actuation element in an inward direction.

The use of the screw driver in connection with a change of the functional parts can be simplified if during insertion of the functional part into the handle the holding device is automatically transferred into the released position. This can be done by providing a contact area between the holding element and the outer surface of the functional part wherein the outer surface comprises a conical region. Due to the slope of the conical region with the insertion of the functional part into the handle, the holding element is moved from the secured position versus the released position. In the end position of the functional part which corresponds to the operational position, the spring element initiates the movement of the holding device into the secured position and brings the holding element into frictional or positive engagement with the functional part. During insertion of the functional part, the actuation element must not be pushed but the hands of the user can be used for gripping the handle and for guiding the functional part.

The aforementioned carrier can be guided in a very simple manner by at least one groove built by an interior opening housing the actuation element.

The spring element actuated by the holding element can be built as a separate spring, for example, a compression spring made of spring steel. In a very simple embodiment, the spring is built integrally with the carrier. In the case where the carrier is built of plastic, the spring element could be a protrusion or tongue extending from the carrier. Such a spring element comprises the advantage that a separate assembly is not necessary. Moreover, an integral spring element made of plastic is not subjected to corrosion.

The torque in a circumferential direction of the screw driver can be transferred by means of a frictional engagement. A very stiff and reliable transfer of the torque can be provided if the end piece is positively engaged with the handle in a circumferential direction. The end piece and the handle comprise correlating cross-sections at least in the contact areas. The cross-sections are non-circular. The handle or the end piece may comprise at least one radial protrusion that engages a corresponding radial cavity of the end piece or the handle.

The forces applied to the contact areas between the end piece and the handle can be decreased if the end piece comprises an increased outer diameter or dimension in the region of these contact areas so that the lever arm of the contact forces is increased. So, the maximum torque that is transferable via these contact areas is increased. Also for large torques, plastics can be used in the contact areas between handle and functional part so that an appropriate insulation of the screw driver can be provided.

The carrier may be designed as a frame structure with a lower part, an upper part and two side elements connecting the lower and upper part. Such a frame structure builds a stiff structure at least in the actuation direction. The side elements can be used for guiding the frame in the aforementioned grooves and can be used to transfer the actuation forces from the upper part to the lower part. The transfer of the actuation forces by means of two side elements could lead to lower dimensions of these side elements, so that a compact design of the holding device and the whole screw driver becomes possible.

Between the handle and the functional part another spring element can be positioned which is compressed in the longitudinal or axial direction of the screw driver. The additional spring element is compressed during the insertion of the functional part into the handle. If the holding device is moved from the secured position to the released position, the additional spring element pushes the end piece and the functional part a short distance out of the handle or throws it completely out. Accordingly, the functional part desirably is not detached from the operational position by means of pulling forces of the user. In order to move the functional part from the operational position, it is sufficient to manually actuate the actuation element. So, the movement of the functional part is automated in a very simple manner. If the functional part is automatically moved for some axial distance out of the handle, this can be a signal for the user that the holding device is in the released position and the functional part is not in the operational position so that the user will not apply any torque to the handle and can pull the functional part with small forces out of the handle. The spring element can be a pushing spring made of steel or a cylinder of an elastic plastic material.

The screw driver according to the invention can additionally comprise a removal position. In the removal position, the functional part is partly released from the handle but is secured against dropping down due to gravity. In the removal position, the functional part can only be removed from the handle by the user.

According to another embodiment of the invention, the functional part is moved from the operational position into the removal position by the additional spring. In the removal position, the functional part is secured with respect to the handle only by means of an elastic snap-in locking device. For a complete removal of the functional part, the user applies forces to the functional part that are larger than the locking forces of the snap-in locking device. It is possible that both the movement from the operational position to the removal position and the complete removal of the functional part are directed in a longitudinal direction of the handle. Alternatively, it is possible that one of the two aforementioned movements comprises also a rotation of the functional part with respect to the handle.

According to the invention, it is also possible that the functional part itself is used as an independent screw driver wherein the shank is covered by the insulating sleeve and/or the end piece. According to this embodiment of the invention, the functional part can be used in a multi-functional manner with or without the handle also for electrical appliances under voltage.

The end piece may have a conical design in a longitudinal direction building a functional surface. In the operational position, the functional surface abuts a conical counter surface of the handle, leading to supporting forces in one longitudinal direction of the screw driver. In the other longitudinal direction of the screw driver which correlates to the direction of movement for a removal of the functional part, the functional part is fixed by means of the holding device.

The inventor has discovered that for securing the functional part in the direction of the removal of the functional part, only small holding forces are necessary between the handle and the functional part. However, in the opposite direction, large supporting forces are necessary due to the fact that for the application of large torques the screw driver is pushed against the screw under large thrust forces directed in a longitudinal direction. If the holding device is used to support the functional part in both axial directions, the holding device has to be designed with large dimensions and increased constructional efforts. According to one embodiment, the invention suggests that the holding device provides holding forces only in the removal direction. In the opposite direction, the holding force for fixing the functional part with respect to the handle is provided by the contact of the conical functional surface of the end piece with the conical counter surface of the handle. The conical contact surfaces provide several advantages:
The conical surfaces can be self-centering.
The conical surfaces can avoid an incorrect assembly.
The conical surfaces guarantee that in the operational position the functional part is radially adjusted with respect to the handle.
In the case of corresponding slopes of the conical surfaces, the orientation of the functional part with respect to the handle is preset so that the longitudinal axis of the functional part and the handle are aligned.
Furthermore, depending on the slope of the conical surfaces, a clamping effect is produced so that with an increase of the axial force pressing the tip against the screw the axial support and radial guiding forces increase in a proportional manner. So, with an increase of the load of the screw driver in axial direction the connection between the functional part and the handle is strengthened.

According to this embodiment of the invention, for securing the functional part against dropping down, only small holding forces have to be provided by the holding device. The holding device can be designed for a suitable actuation, suitable actuation forces, a suitable location of the actuation element and the desired holding force. The holding device can be constructed in a very simple manner and/or be designed for small constructional spaces.

A removal of the functional part from the handle can be simplified if the slope of the conical surfaces is chosen to be larger than the self-locking angle of the contacting materials of the handle and the functional part.

The interchangeable functional part can be supported with its end piece in the operational position by means of a first functional surface in one axial direction against a corresponding first counter surface of the handle. The aforementioned surfaces can be the conical surfaces explained above or can be surfaces oriented laterally with respect to the longitudinal axis of the screw driver. According to this embodiment, the handle includes a thread. The holding device, which could be a swivel nut in this case, comprises a second counter surface and a thread. The second counter surface abuts a second functional surface of the functional part. The holding device and the handle are connected with each other by the aforementioned threads. By means of screwing of these threads the distance of the first counter surface and the second counter surface can be varied and/or the contact forces of the functional part at the first functional surface and the second functional surface are changed. By advancing the threads, the functional part can be clamped between the counter surfaces. The screw joint provides a very reliable holding device which is independent of existing tolerances, productional inaccuracies and strain or deformations due to a change of the temperature. On the other hand, a holding device with the screw joint is adjustable.

In some cases, the force conditions can be optimized if the second counter surface is built by an inner conical surface of the holding device.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIGS. 1A, 1B, 1C are top views of screw drivers according to the present invention with different functional parts, wherein in FIG. 1A a handle of the screw driver is partially broken away.

FIG. 2 is a longitudinal sectional view through a functional part of the screw driver of FIG. 1A, wherein an insulating sleeve and an end piece are moulded as one piece onto a shank of the screw driver.

FIG. 2A is a longitudinal sectional view through another embodiment of a functional part suitable for use with the screw driver of the present invention, wherein the insulating sleeve and the end piece are moulded in two injection operations onto the shank of the screw driver.

FIG. 3A is a cross-sectional view through the end piece of FIGS. 2 and 2A taken along line III-III, the cross-sectional shape thereof being substantially rectangular.

FIG. 3B is a cross-sectional view through the end piece of FIGS. 2 and 2A taken along line III-III, showing another cross-sectional shape thereof.

FIG. 4 is a front view of a locking element of a first embodiment of a holding device suitable for use with the screw driver of the present invention.

FIG. 4A is a front view of another embodiment of a locking element suitable for use with a holding device.

FIG. 5 is a cross-sectional view through the holding device taken along line V-V in FIG. 6.

FIG. 6 is a longitudinal sectional view through the handle with the functional part inserted therein, the shank being partially broken away.

FIG. 7 is a longitudinal sectional view through the handle with the functional part inserted therein, the shank and the rear part of the handle being partially broken away, showing a second embodiment of the holding device.

FIG. 8 is a longitudinal sectional view according to FIG. 7, showing a third embodiment of the holding device.

FIG. 9 is a longitudinal sectional view according to FIG. 7, showing a fourth embodiment of the holding device.

FIG. 10 is a partial top view of a screw driver, showing a fifth embodiment of the holding device.

FIG. 11 is a longitudinal sectional view taken along line XI-XI of the fifth embodiment of the holding device according to FIG. 10.

FIG. 12 is a longitudinal sectional view according to FIG. 7, showing a sixth embodiment of the holding device.

FIG. 13 is a longitudinal sectional view according to FIG. 7, showing a seventh embodiment of the holding device.

FIG. 14 is a longitudinal sectional view according to FIG. 7, showing an eighth embodiment of the holding device.

FIG. 15 is a longitudinal sectional view according to FIG. 7, showing a ninth embodiment of the holding device.

FIG. 16 is a cross-sectional view through the holding device taken along line XVI-XVI according to FIG. 15.

FIG. 17 is a top view of the functional part with a swivel cap, partially broken away, which is mounted to the pin at the rear end of the end piece.

FIG. 18 is a longitudinal sectional view according to FIG. 7, showing a tenth embodiment of the holding device.

FIG. 19 is a cross-sectional view through the holding device as shown in FIG. 18 taken along line XIX-XIX.

FIG. 20 is a longitudinal sectional view according to FIG. 7, showing an eleventh embodiment of the holding device.

FIG. 21 is a cross-sectional view through the holding device as shown in FIG. 20 taken along line XXI-XXI, wherein the holding device is shown in a secured position.

FIG. 22 is a cross-sectional view according to FIG. 21, wherein the holding device is in a released position.

FIG. 23 is a cross-sectional view through the holding device as shown in FIG. 20, taken along line XXIII-XXIII.

### DETAILED DESCRIPTION OF THE INVENTION

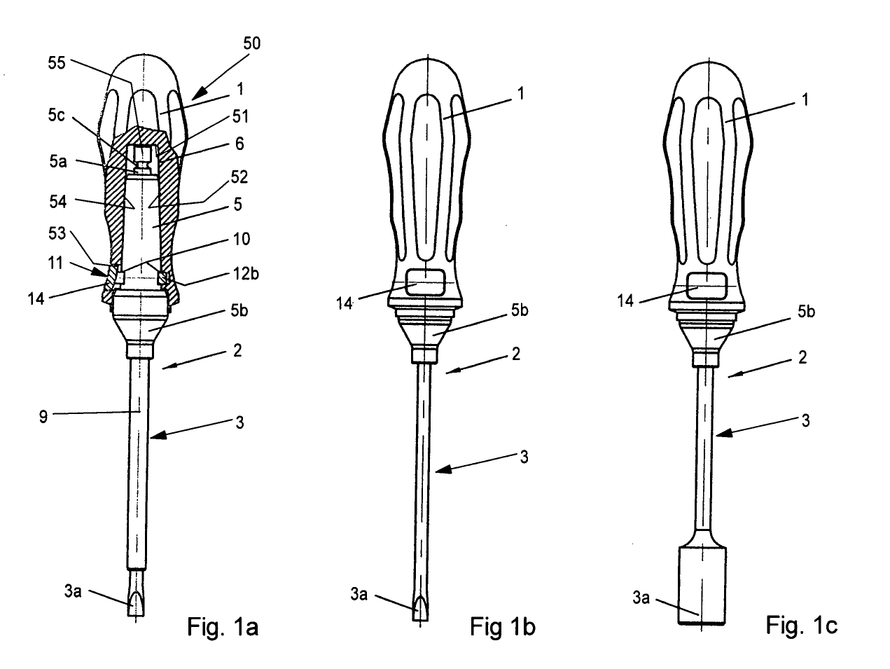

As can be seen in FIG. 1, a screw driver 50 according to the invention comprises a handle 1 and a functional part 2 inserted in a cavity 6 of the handle. A force applied in one longitudinal direction of the handle 1 and a torque are transmitted via a shank 3 to a functional tip 3a of the functional part 2.

The handle comprises a cavity 6 extending from the end wall of the handle 1 in a longitudinal direction, having a base 51 and conical counter faces 52 building a lateral limit of the cavity 6 and a radial opening 53.

In the front part, the end piece 5 is provided with a head 5b which is significantly larger in diameter than the rear end of the end piece. For sealing purposes a gasket can be positioned between the head 5b and the handle 1. The gasket can be an elastic layer of plastic which is fixed to the outer surface of the head 5b or a sealing ring compressed between the head 5b and the handle 1. The end piece 5 comprises functional surfaces 54 that are inclined with respect to the longitudinal axis of the screw driver 50 by an angle α. At its rear end the functional part 2 comprises a pin 5a, a circular groove 5c and a cylindrical end 55. In the illustrated operational position the functional part 2 is inserted into the handle 1 so that the functional surfaces 54 contact the counter surfaces 52 and/or the abutting surface of the cylindrical end 55 contacts the base 51 of the cavity 6, so that in the shown operational position the axial position of the functional part 2 is fixed with respect to the handle 1. A holding device 11 is inserted into the opening 53 to additionally secure the axial position of the functional part 2 and/or to secure the functional part 2 with respect to the handle 1 against a relative rotation. Both the functional surfaces 54 and the contact areas contacting the holding device 11 are built by the end piece 5 of the functional part 2.

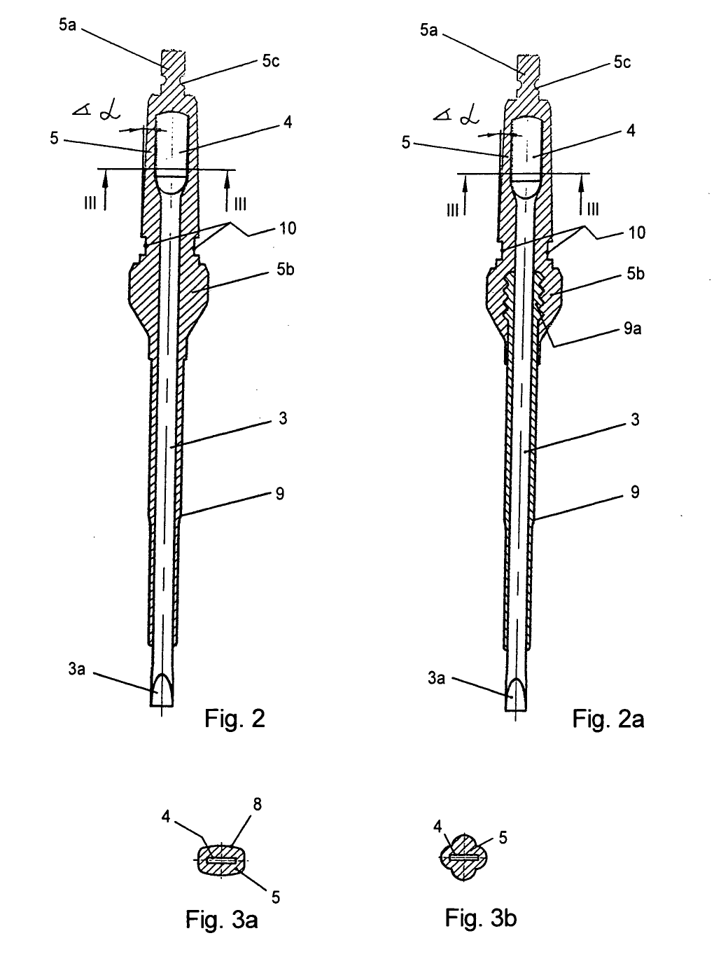

The end piece 5 of the functional part 2 contacts the counter surfaces 52 of the cavity 6 in the handle 1 with its functional surfaces 54 substantially without play. The depth of the cavity is somewhat deeper than the length of the end piece 5. In addition, the play-free seating is ensured by the frustoconical shape of the end piece 5 and the cavity 6. The cone angle (α) (see FIG. 2) is preferably selected to be larger than the interlocking angle of the materials selected for the handle 1 and the end piece 5. In this way, the end piece 5 is prevented from being seated too firmly in the cavity so that the functional part may be pulled out of the handle 1 without an additional aid. For an alternative embodiment the cone angle α is preferably selected smaller than the interlocking angle. However, the width and the length of the cavity 6, the outer contour of the end piece 5 and the length of end 55 are adapted so that an interlocking of the functional part 2 in the handle 1 is prevented by these dimensions and the front surface of the end 55 abuts the base 51 of cavity 6.

For a precise fit with the functional surfaces 54 contacting the counter surfaces 52 without play, it could be helpful if the functional surfaces 54, the counter surfaces 52 and/or end 55 are elastic in longitudinal direction.

FIGS. 1A to 1C show the identical handle 1 with three different functional parts 2, namely according to FIG. 1A a functional part 3 with an insulating sleeve 9 and a functional tip 3a adapted for use with a slotted screw, according to FIG. 1B a functional part 2 without insulating sleeve 9 and a functional tip 3a adapted for use with a slotted screw and according to FIG. 1C a functional part 2 with a functional tip 3a with increased diameter, for example for holding a bit.

Referring to FIG. 2 the end piece 5 encloses a torque-transmitting surface 4 of the screw driver shank 3 with the functional tip 3a. The body of the end piece 5 is applied, together with the insulation sleeve 9, onto the shank 3 and its torque-transmitting surface 4 in one piece in one injection moulding operation and covers it with the exception of the functional tip 3a in such a way that complete electrical insulation is achieved. Furthermore, the cone angle α is shown, which preferably exists on all four sides of the end piece 5. A recess, groove or a shoulder 10 is formed into the upper and lower side of the end piece. The locking element of the holding device 11a may engage the lower recess (see FIG. 1A).

FIG. 2A shows an example of a functional part, in which the insulation sleeve 9 and the end piece 5 are not applied to the screw driver shank 3 in one piece in one injection moulding operation, but rather in two steps. In a first operation, the shank 3 is coated with the insulation sleeve 9 which has at its end region 9a a plurality of annular ribs applied concentrically along the longitudinal axis. In the second operation, the end piece 5 is moulded onto the functional part. The head 5b of the end piece 5 encloses the end region 9a of the insulation sleeve 9 to form a seal.

In FIG. 3A a cross-section through the rear part of the end piece 5 along line III-III in FIGS. 2 and 2A, the position of the torque-transmitting surface 4 relative to the lateral extension of the end piece 5 is demonstrated. The largest width of the torque-transmitting surface lies in the direction of the largest lateral extension of the end piece, in order to thus achieve a large thickness of the plastic sheath even at the narrow sides of the torque-transmitting surface, and also to have the largest possible lever during the transmission of the torque from the handle 1 to the torque-transmitting surface via the end piece 5. The cross-section along line (III-III) through the end piece also shows the curve of the lateral surfaces 8.

FIG. 3B shows a cross-section along line III-III as before in which an alternative non-circular contour of the rear part of the end piece is shown.

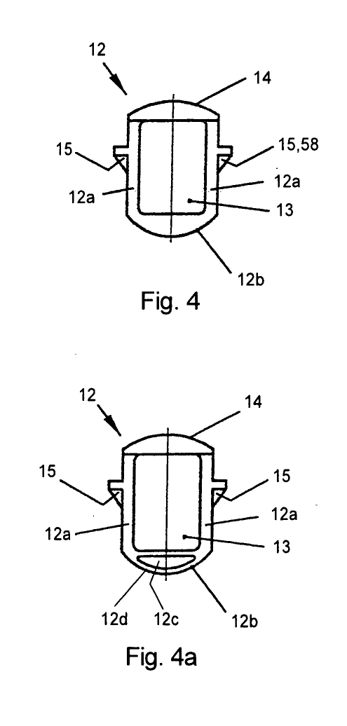

FIG. 4 shows the locking element 12 of a first embodiment of the holding device 11 in a view from the front. According to this embodiment the holding device 11 comprises a carrier or frame element 12 with an actuation element 14, side elements 12a, a lower part 12b, a central opening 13, so that a substantially rectangular frame is built. The actuation element comprises a curvilinear exterior contour which corresponds to the contour of the handle 1. The contour of the lower part 12b is also curvilinear and approximates the inner contour of the base 57 of the opening 53. The locking element 12 is moulded of plastic material. A pair of support cams 15 moulded onto lateral parts 12a of the locking element 12 have bevels laterally offset from the support elements for receiving springs. The support cams cause the lateral parts 12a to bend inwardly in the direction toward an interior opening 13 when the locking element is inserted into the handle 1 and allow the locking element to be pushed through the opening 5a in the handle. As soon as the support cams 15 enter the cavity 6 in the handle, the lateral parts 12a can spring back outwardly and the tops of the support cams now form stops resting against the wall of the cavity 6 from below in the locking position and prevent the locking element from being pressed out of the handle by the spring force. A lower part 12b of the locking element engages a recess 10 of the end piece 5. The locking element also includes an actuating surface 14.

Referring to FIG. 4A, a variation of the embodiment of the locking element 12 is shown. The lower part 12b bulges out more strongly and has an opening 12c, thereby defining a bridge-like arc 12d. When the arc 12d is deformed inwardly in the direction of the opening 12c, an opposing radially acting spring force arises. In order that a spring force acts on the locking element 12, the dimension from the top of the support cams 15 to the lowest point of the arc 12d is determined to be larger than the distance from the point of the inner wall of the cavity 6 of the handle 1 at which the top of the support cams 15 rests against the lowest point of the cavity, measured in the radial direction. As a result, when the locking element is inserted into the handle, the arc 12d is bent inwardly in the direction toward the opening 12c and presses the lower part 12b of the locking element into the recess 10 in the end piece elastically from below. By pressure on the actuating surface 14, the locking element 12 is displaced further radially and the arc 12d is bent-in somewhat further. The height of the opening 12c and the cross-section of the arc 12d can be selected so that at the point of maximum inward-bend no plastic deformation occurs and a lasting desired spring force is achieved.

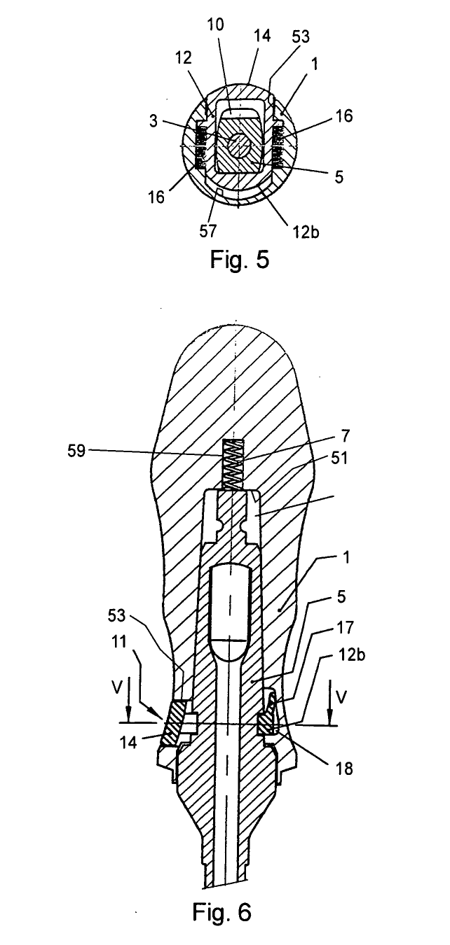

The position of the locking element 12 inside the handle 1 in a locking position is illustrated in FIG. 5. The locking element 12 shown in FIG. 4 of the locking device 11 engages in the lower recess 10 in the end piece 5, locks it, and thus prevents the functional-part 2 from unintentionally falling out of the handle 1. If the locking element 12 is pressed downward against the springs 16 through finger pressure on the actuating head 14, for example, the lower part 12b of the locking element is moved out of the lower recess 10 in the end piece 5, thereby allowing the functional part 2 along with the end piece to be pulled out of the handle 1. Another functional part may be inserted into the cavity 6 of the handle when the locking element is in this position. If pressure is no longer exerted on the locking element, the element rises again until it engages the recess 10 in the end piece 5 so that it is locked.

FIG. 6 shows another embodiment of the locking element 12. A tongue-shaped extension 17 is integrally moulded with the lower part 12b of the locking element, which is preferably made of elastic plastic, in one piece. The extension extends in the longitudinal direction of the handle 1 and is slanted at an angle relatively to the wall of the handle cavity. The angle and the length of the extension 17 are selected so that the extension is supported elastically on the wall of the cavity and thus exerts a force acting in the radial direction on the locking element. The strength of the force is determined by selecting the cross-section of the extension and its length. The extension 17 is preferably disposed in a recess 18, which is moulded into the wall of the cavity 6 in longitudinal direction. Furthermore, it may be seen how the lower part 12b of the locking element engages in the lower recess 10, while the actuating surface 14 is substantially flush with the surface of the handle 1.

The compression spring 7, disposed in a hole extending from the base of the cavity 6, is compressed and thus set under tension when a functional part 2 and end piece 5, are inserted. If the end piece is unlocked by pressure on the actuating surface 14, the spring pushes the end piece and the functional part a short distance out of the handle 1.

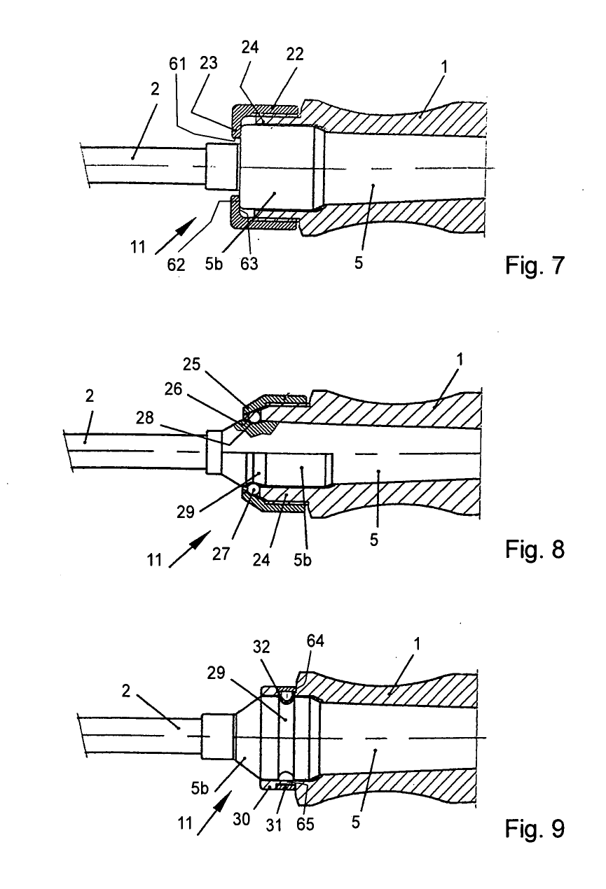

FIG. 7 illustrates a second embodiment of the holding device 11 wherein at the front side of the handle 1 an extension 24 with an external thread is provided as one piece with the handle. Onto this extension 24 a screw cap 22 made of plastic material is engagingly threaded. A front wall 23 of the screw cap has a bore with a diameter smaller than the diameter of the diameter of the head 5b of the end piece or the diameter of the end piece itself if no head is provided. To insert the end piece 5 into the handle, the screw cap can be unscrewed from the extension. The functional part 2 with the end piece can be inserted into the cavity of the handle. The screw cap 22 can be placed over the functional tip 3a and the shank of the screw driver with the shank extending through the bore of the screw cap 22. The screw cap 22 can be screwed onto the extension 24 until the inner side of the front wall 23 contacts the front side of the head 5b, thereby pressing the end piece into the cavity of the handle.

The exterior front surface of head 5b builds additionally to the functional surfaces 54 second functional surfaces 62. With continued screwing of the screw cap 22 a second counter surface 63 built by the front wall 23 of the screw cap 22 advances towards the second functional surface 62 and finally abuts the functional surface 62. The screw cap 22 can be provided only for securing the functional part 2 or to determine the contact force between the functional surfaces 54, 62 and counter surfaces 52, 63, so that in case of a frictional engagement in circumferential direction between functional part 2 and handle 1 the maximum torque that could be transmitted is increased.

A third embodiment of the holding device 11 is shown in FIG. 8. The screw cap 25 is provided with an inner cone 26 building a second counter surface 63, which contacts a ball 27 disposed in a radial bore in the extension 24. The diameter of the ball is larger than the thickness of the wall of the extension and the ball is protruding into the cavity of the handle. If the screw cap is tightened the ball is pressed onto the head 5b of the end piece and holds it by a non-positive/friction-locking connection. Preferably the head is provided with a circular groove 28 so that a positive/form-locking connection is achieved. The advantage of this embodiment, compared with the embodiment of the holding device 11 in FIG. 7 is that the screw cap need not be unscrewed completely from the extension to insert the functional part because the boring in the front wall of the screw cap may be so wide that the end piece with a head 5b can pass through the boring. The ball 27 is preferably made of a high-strength plastic material.

In an alternative embodiment, the end piece does not have a head, and the ball rests in a cavity 28 which is formed into the end piece. The lower half of FIG. 8 shows the embodiment of the end piece with the head 5b and the circular groove 29 into which the ball engages once the screw cap is tightened. The upper half of FIG. 8 shows the embodiment wherein the end piece is not provided with a head, and the ball rests in the cavity 28. If the screw cap is loosened, the ball can move radially outward and disengage from the cavity or circular groove. Then the end piece/functional part 2 can be removed from, or inserted into, the handle.

A fourth embodiment of the holding device 11 is illustrated in FIG. 9. In this embodiment, the handle 1 is provided at the front side with an extension 30 into which a circular groove is moulded. From this circular groove, at least one radial recess extends to an axial boring in the extension 30 or the cavity 6 of the handle. A ring spring 31 is inserted into the circular groove. The ring spring 31 is preferably made of plastic material and is provided with an extension 32 which protrudes into the boring or the cavity of the handle. The end piece 5 may be provided with a head 5b having a circular groove or without a head but with a cavity as described before. The ring spring engages the groove or cavity to hold the end piece and the functional part 2 by a preferred friction-locking connection. If the ring spring is made from a material with a hard characteristic, it may not be required to form a groove or cavity into the head or end piece. In such a case, the end piece can be held by a non-positive/friction-locking connection.

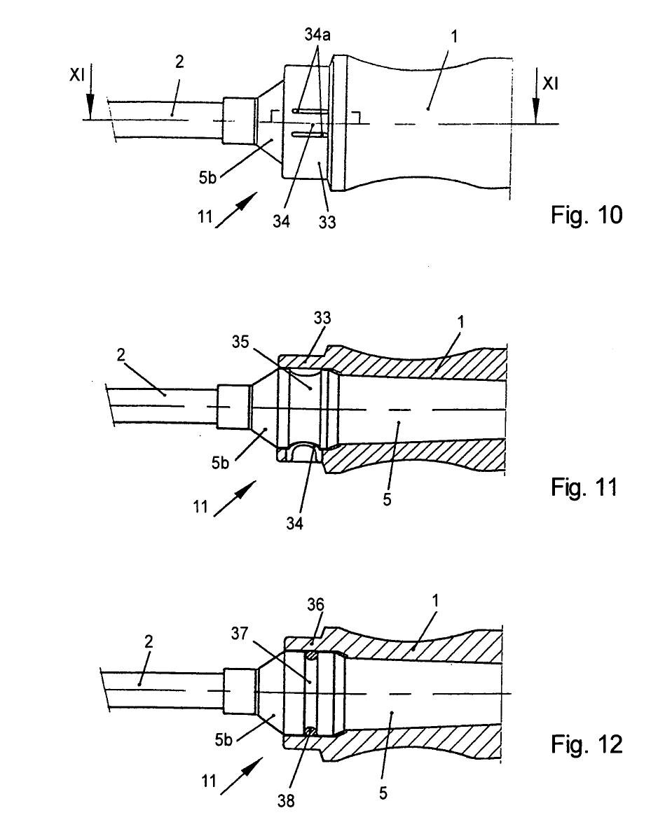

In a fifth embodiment of the holding device 11, as shown in FIGS. 10 and 11, a saddle- or tongue-like spring element 34 is integrally moulded into the extension 33. The lower part of the spring element protrudes into the boring in the extension and works in the same way as the ring spring with the extension shown in FIG. 9. FIG. 10 is a top view of the holding device. FIG. 11 is a longitudinal section through the handle of FIG. 10 taken along the line XI-XI with an offset in the area of the saddle-like spring element.

A sixth embodiment of the holding device 11 is illustrated in FIG. 12. Into the head 36 of the end piece 5 a circular groove 37 is provided into which a ring 38 made of resilient material, such as rubber or soft plastic, for example, is inserted. The outer diameter of the ring is selected such that it is larger than the outer diameter of the head 5b so that the ring surface protrudes from the surface of the head. The inner diameter of the axial bore in the handle is also smaller than the outer diameter of the resilient ring. If the end piece is inserted into the bore, the resilient ring is compressed and the end piece is held by a non-positive/friction-locking connection in the handle 1.

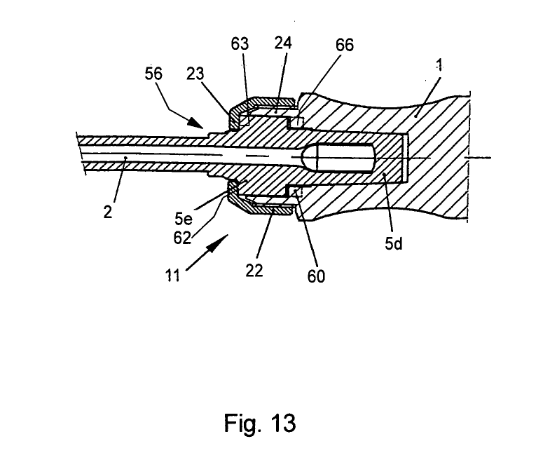

FIG. 13 illustrates a seventh embodiment of the holding device 11. As in the embodiments described before, there is a difference in diameter between the rear cavity 6 in the handle 1 and the bore in the front part so that a step results from this difference. In this embodiment of the holding device 11, a gearing 39 is formed into this step and a corresponding gearing at the rear side of the head 5e engages into the gearing 39. The orientation of the gearing may be axial, as shown in FIG. 13, or radial, for example. A screw cap 22 is screwed onto the extension 24 and engages the front wall 23 of the head 5e, thus holding the end piece/functional part 2 in the handle. For the gearing, preferably a rectangular tooth profile is chosen. With the torque being transmitted via the gearing from the handle to the functional part, the rear part 5d of the end piece may have either a non-circular cross-sectional shape or a circular shape.

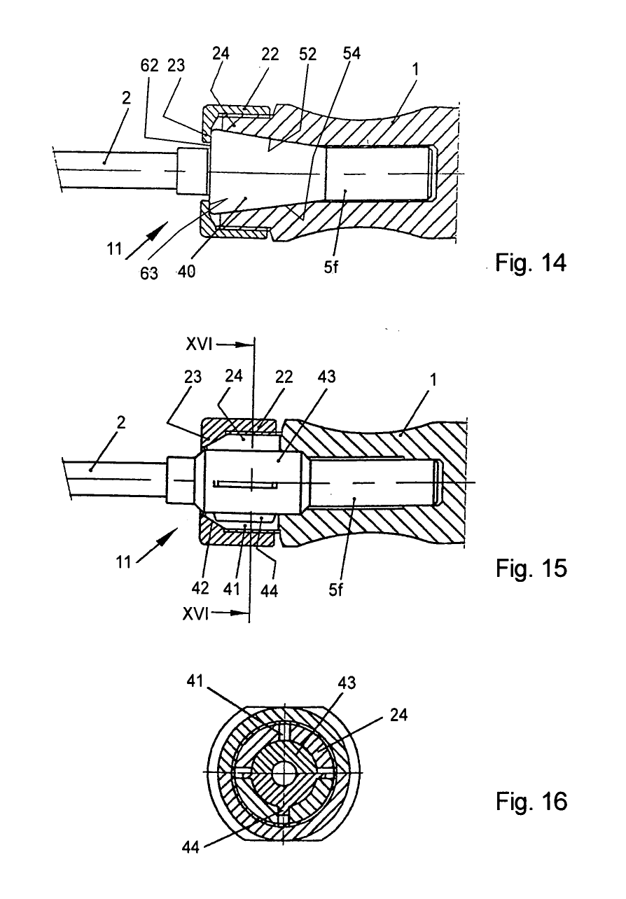

The holding devices as described in conjunction with FIGS. 1 to 13 are characterized by noncircular form-locking connections between the handle and the end piece to transmit a torque from the handle into the functional part. For hand screw drivers, friction-locking connections may also be suitable to transmit the torque required for normal use. For this reason, embodiments of holding devices that achieve a friction-locking connection are described as part of the present invention. Such a holding device 11 is illustrated in FIG. 14. In this embodiment, the rear part 5f of the end piece is a cylindrical pin, and the front part 40 is a portion of a cone. If the screw cap 22 is screwed onto the extension 24, it contacts the front wall 23 of the cone portion and presses the end piece into the conical cavity in the handle 1, thereby achieving a friction-locking connection.

Another friction-locking torque transmitting holding device 11 is illustrated in FIG. 15. The holding device 11 is designed as a chuck: the extension 24 is provided with radial slots 41 and with a cone at the front side. The screw cap 22 has an inner cone 42 in the front part. If the screw cap is tightened the cone of the cap exerts a radial force onto the cone of the extension and presses the segments of the extension onto the cylindrical front part 43 of the end piece to thereby clamp it. The front part 43 may also be provided with radial ribs 44 which engage slots 41 of the extension, thus creating additionally a form-locking connection. This variation is shown in the lower half of FIG. 15. The rear part 5f of the end piece can be shaped as a cylinder which is disposed in the bore of the handle 1. A further illustration of the holding device 11 is given in FIG. 16, the cross-section being taken along line XVI-XVI of FIG. 15. FIG. 16 shows the slots 41 in the extension 24, the cylindrical front part 43 of the end piece and the radial ribs 44 of the cylindrical part 43.

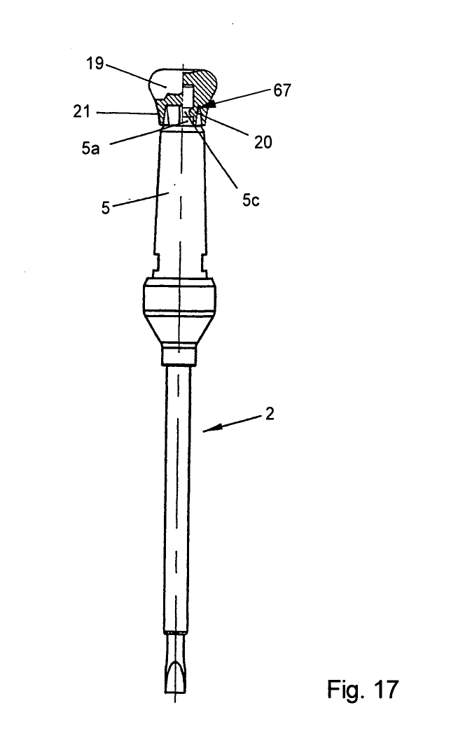

FIG. 17 shows another appliance of the functional part 2: a cap 19 is seated on the pin 5a of the end piece 5. The cap 19 is secured in axial direction, but rotates with respect to the longitudinal axis of the functional part 2. The circular groove 5c is moulded into the pin. Elastic segments 20 of an otherwise sleeve-shaped collar 21 of the cap, which is slotted in the lengthwise direction, engage in the circular groove 5c. The segments have ring cams arranged in a circular fashion on the inside, which engage with play in the circular groove 5c and secure the cap actually, but allow it to rotate freely. Also the end pieces 5 of the embodiments shown in FIGS. 7-15 can be provided with a pin 5a. When the cap 19 is put on and pulled off, the segments 20 spring back radially. The cap is supported in the axial direction with the bottom of the axial hole on the top of the pin 5a when loaded. It rotates easily, especially when an axial load is only applied by one finger to guide the tool during screwing. The pin 5a and the circular groove 5c build an additional functional surface of the functional part 2 designed to cooperate with cap 19 and to provide a detachable connection of the functional part 2 with cap 19. Also for this connection an insulation is provided between the shank 3 and the cap 19. The functional part comprises both a functional surface 54 and an additional functional surface 67, so that a multi-functional use of the functional part is possible.
a) Different functional parts 2 can be used with one single handle 1.
b) Without the use of the handle 1 the functional part 2 can be used with the cap 19. One finger of the user, which contacts cap 19, presses functional part 2 against a screw, whereas the other hand of the user operates the functional part in circumferential direction.

The use of the functional part with the handle 1 as well as the use of the functional part without handle but with the cap fulfils insulating requirements for electrical appliances under voltage.

The dimensions of the handle are designed so that forces—such as torque or thrust forces—that may arise during use of the tools may be transmitted without particular exertion. In order to achieve a comfortable and non-slipping surface, the surface of the handle is largely coated by soft plastic material, which is moulded onto a core handle made of hard plastic material.

According to a predetermined field of application, sets comprising a handle, a swivel cap, and a variety of functional parts may be combined and handily packed in a box.

The scope of the present invention will also cover other embodiments of the end piece and holding devices of other kinds than those illustrated and described before. In the figures, the end piece is illustrated with the head 5b having a circular cross-section shape. This shape is able to shut the opening of the cavity or boring in the handle; it is also well adapted to the substantially circular cross-sectional shape of the front side of the handle 1 or the extension 24. A circular shape of the front side of the extension gives also a good contact surface for the screw cap 22. The non-circular cross-sectional profile of the rear part of the end piece 5 as illustrated in FIGS. 1-13 may continue along the whole longitudinal extension of the end piece as shown in the upper half of FIG. 8. A screw cap can contact the end piece directly at the step from the end piece to the insulation sleeve 9 or a ball can rest under pressure in a cavity of the front section of the end piece. A resilient ring may also be inserted into a groove around the surface of the end piece having a non-circular cross-sectional profile. The cavity in the handle may be configured with a corresponding shape such that the resilient ring is squeezed when the end piece is inserted into the handle, thereby resulting in a friction locking connection of both parts.

The embodiments of the holding devices according to FIGS. 1-13 provide a firm seating of the functional part in the handle, even if a pulling force is applied to the functional part. The embodiments according to FIGS. 14-16 are able to hold the functional part if there is no strong pulling force applied to it. Of course, the designs of the end piece and the holding device are also applicable to functional parts without the insulating sleeve.

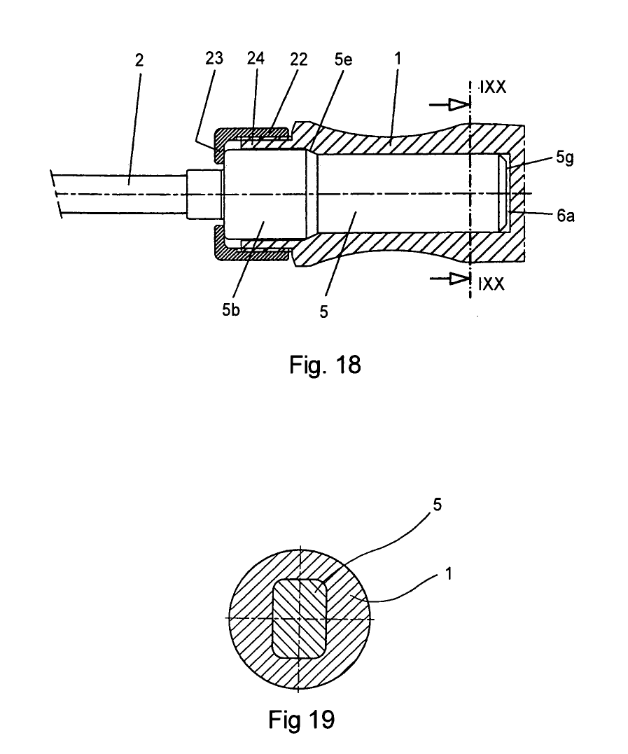

According to the embodiments shown in FIGS. 18 and 19 the end piece 5 is not shaped with cones but comprises a constant cross-section which in particular is rectangular. The cavity 6 of handle 1 comprises a correlating cross-section. The dimensions and contours of the cross-sections of end piece 5 and cavity 6 are correlated with each other in order to achieve a seating of the end piece 5 in the cavity 6 without play and in order to provide a good transfer of a torque between handle 1 and end piece 5. The end piece 5 comprises a step 5e or shoulder or collar which is located in the transitional area of the rear part of end piece 5 to head 5b. The step 5e abuts a corresponding step of the cavity 6. The exterior front area of head 5b builds a second functional surface 62 abutting a counter surface 63 built by the front wall 23 of screw cap 22. Screwing the screw cap 22 with extension 24 compresses the end piece 5 between front wall 23 and step 5e so that functional part 2 is held within the handle 1. Instead of the contact with step 5e the end piece 5 may contact the base 51 of cavity 6 with its end surface 5g.

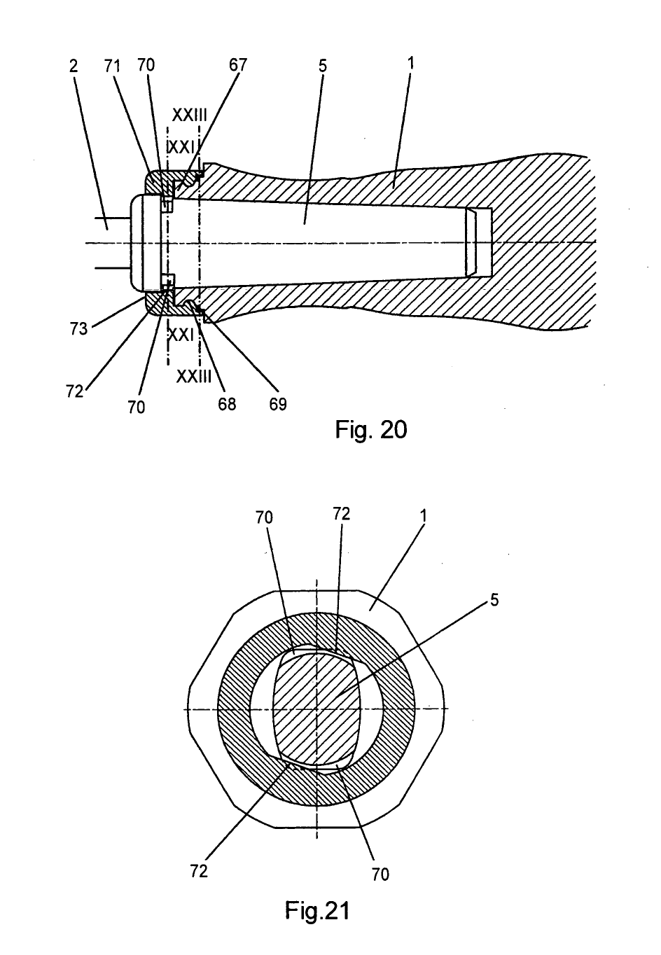

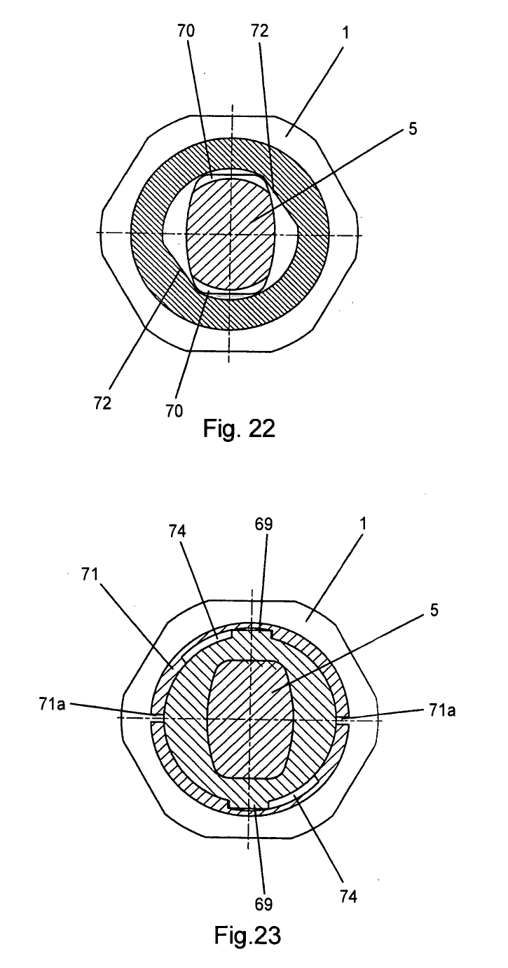

Another embodiment of a holding device that positively engages functional part 2 is shown in FIG. 20. The handle comprises in its front end region an integrally built cylindrical extension 67 with a moulded circular groove 68. By means of a snapping connection a screw cap 71 engages the circular groove 68. The screw cap 71 comprises an opening that extends from the front wall 73 in longitudinal direction. Through the opening the end piece may be inserted into the cavity 6 of handle 1. The end piece 5 comprises in its front region two cavities 70 that are moulded opposite to one another in circumferential direction. In the secured position of the holding device two cam-like segments 72 that extend from the cylindrical inner surface of screw cap 71 engage in the cavities. For securing the end piece 5 inserted into handle 1, so for holding the functional part 2, screw cap 71 is rotated according to FIG. 21 in counter-clockwise direction, in particular from 2 o'clock position as well as 8 o'clock position of segments 72 (released position, FIG. 22) to a 12 o'clock position as well as 6 o'clock position of segments 72 (secured position, FIG. 21). By way of rotating the segments 72 the segments come into engagement with cavities 70 of end piece 5 to build at least an axial positive engagement with handle 1. For the other direction of rotation the segments 72 are released from cavities 70 and become positioned laterally of end piece 5. In the secured position according to FIG. 22 end piece 5 can be pulled off the handle 1, so that another functional piece 2 may be inserted into handle 1. In case that the contacting surface of cavities 70 and segments 72 have a spiral design screwing of screw cap 71 effects an axial compression of end piece 5 in cavity 6 of handle 1 additionally to the positive engagement in axial direction.

The angle of rotation of screw cap 71 can be limited by means of abutting cams 69 that are built integrally of the front region of handle 1. As a result for an exchange of the functional parts 2 the angle the screw cap 71 has to be rotated may be minimized. Additionally due to the predetermined end position of screw cap 71 the screw cap is rotated to a position which is aligned with the opening of cavity 6 so that the functional part 2 can be inserted into handle 1 without any additional adjusting activities. The abutting cams 69 engage cavities 74 in the rear end of screw cap 71. FIG. 23 shows the engaging situation of the aforementioned device for limiting the angle of rotation. The screw cap 71 comprises two slots 71a in its rear part. The slots 71a provide the possibility of an elastic deformation that is directed in radial and outward direction when the screw cap is pushed upon the cylindrical extension 67 in order to build a snapping connection between screw cap and handle.

Many variations and modifications may be made to the preferred embodiments of the invention without departing substantially from the spirit and principles of the invention. All such modifications and variations are intended to be included herein within the scope of the present invention, as defined by the following claims.

1. An insulated screw driver for use with electrical appliances under voltage, comprising:
a handle;
a functional part, said functional part including a shank and an end piece,
said shank being designed to be partly covered by an insulating sleeve made of plastic,
said end piece being designed to be insulated, to be connectable to said handle and to transmit torque from said handle to said functional part,
said handle being insulated from said shank; and
a holding device, said holding device being connected to said handle, said holding device being designed to have a secured position and a released position and to be manually operable between the secured position and the released position,
said holding device in the secured position positively engaging said functional part such that said functional part cannot be detached from said handle,
said holding device in the released position allowing for said functional part to be detached from said handle.

2. The screw driver of claim 1, wherein said handle is electrically insulated from said shank by an intermediate arrangement of an at least one insulating element selected from the group consisting of said insulating sleeve, said end piece and said holding device.

3. The screw driver of claim 1, wherein said insulating sleeve has a surface area, said holding device being designed to engage the surface area of said insulating sleeve.

4. The screw driver of claim 1, wherein said holding device is designed to engage said end piece.

5. The screw driver of claim 1, wherein said insulating sleeve has a surface area, said holding device being designed to engage the surface area of said insulating sleeve and said end piece.

6. The screw driver of claim 1, wherein said holding devices includes an actuation element, said actuation element being designed and arranged to move said holding device from the secured position to the released position by manual actuation of said actuation element in a radial direction.

7. The screw driver of claim 6, wherein said holding device includes at least one spring element, said spring element being designed and arranged to be compressed when said actuation element is actuated and to move said holding device to the secured position without manual action of said actuation element.

8. The screw driver of claim 6, wherein said holding device includes a holding element, said holding element being designed and arranged to be operatively connected to said actuation element, said holding element being designed and arranged to positively engage said functional part in the secured position of said holding device.

9. The screw driver of claim 6, wherein said holding device includes a holding element, said holding element being designed and arranged to be operatively connected to said actuation element, said holding element being designed and arranged to frictionally engage said functional part in the secured position of said holding device.

10. The screw driver of claim 6, wherein said functional part has a surface area and said holding device includes a frame element including a holding element, at least one side element and a portion, said holding element being designed and arranged to engage said functional part, said side element being designed and arranged to surround at least a part of the surface area of said functional part, said portion being arranged opposite to said holding element, and said portion being operatively connected to said actuation element.

11. The screw driver of claim 7, wherein
said functional part is designed in a way that said holding device automatically reaches the release position during an initial inserting movement of said functional part into said handle and into said holding device, and
said functional part is designed in a way that said spring element causes said holding device to reach the secured position during the continued insertion movement of said functional part into said handle and into said holding device to reach an end position.

12. The screw driver of claim 10, wherein said frame element and said actuation element are designed as one piece.

13. The screw driver of claim 12, wherein said handle includes an opening and a plurality of radial channels, said radial channels being connected to said opening, said actuation element being arranged in said opening.

14. The screw driver of claim 10, wherein said holding device includes at least one spring element, said frame element and said spring element being designed as one piece.

15. The screw driver of claim 10, wherein said holding device includes at least one spring element and said frame element includes two supporting cams, said supporting cams being designed and arranged to contact said at least one spring element.

16. The screw driver of claim 15, wherein said supporting cams are designed and arranged to determine an end position of a radial movement of said holding element.

17. The screw driver of claim 1, wherein said handle and said end piece are designed and arranged to positively engage one another in a circumferential direction such that torque may be transmitted about a longitudinal axis of said screw driver.

18. The screw driver of claim 17, wherein said end piece in the region of the positive engagement with said handle has increased dimensions compared to said shank.

19. The screw driver of claim 10, wherein said frame element includes a lower part, a side element and an upper part,
said lower part constituting said holding element,
said side element being designed and arranged to guide said frame element in a radial direction with respect to said handle, and
said upper part constituting said actuation element.

20. The screw driver of claim 7, wherein said handle includes at least one spring element, said spring element being designed and arranged to be compressed in the secured position of said holding device and to push said functional part at least partly out off said handle during movement of said holding device towards the released position.

21. The screw driver of claim 1, wherein said screw driver has an operating position and said holding device has a removal position,
said holding device being fixedly connected to said handle in the operating position, the operating position corresponding to the secured position of said handle,
said functional part being partly detached from said handle in the removal position,
said functional part not being detachable from said handle due to gravity in the removal position, and
said functional part being detachable from said handle by a user in the removal position.

22. The screw driver of claim 1, wherein said end piece has a shape and said handle includes a cavity having a shape, the shape of said cavity of said handle and the shape of said end piece being coordinated in a way that said end piece is located in said cavity substantially free from backlash when transmitting torque with said screw driver.

23. The screw driver of claim 1, wherein said end piece has a shape and said handle includes a cavity having a shape, the shape of said cavity of said handle and the shape of said end piece being coordinated in a way that said end piece is located in said cavity substantially free from backlash when transmitting an axial load to said screw driver.

24. The screw driver of claim 1, wherein said functional part is designed to be usable as an insulated screw driver without being connected to said handle.

25. The screw driver of claim 1, wherein said end piece is designed to have a conical surface in a first longitudinal direction and said handle is designed to have a conical counter surface in the first longitudinal direction,
said conical surface of said end piece being supported at said conical counter surface of said handle in the first longitudinal direction, and
said end piece being supported by said holding device in a second longitudinal direction.

26. The screw driver of claim 25, wherein said conical surface and said conical counter surface have a cone angle which is greater than a self-locking angle of the combination of materials of said handle and said end piece.

27. The screw driver of claim 1, wherein
said end piece has a first functional surface and a second functional surface,
said handle has a first counter surface corresponding to said first functional surface of said end piece, said first functional surface and said first counter surface being designed to be supported on one another in an axial direction in an operating position of said screw driver,
said handle includes a thread, and
said holding device includes a second counter surface and a thread, said second counter surface being designed to cooperate with said second functional surface of said end piece, said holding device and said handle being designed to be connected by said threads engaging, said threads cooperating such that a variation of the engagement of said threads changes a distance between said first counter surface and said second counter surface.

28. The screw driver of claim 1, wherein
said end piece has a first functional surface and a second functional surface,
said handle has a first counter surface corresponding to said first functional surface of said end piece, said first functional surface and said first counter surface being designed to be supported on one another in an axial direction in an operating position of said screw driver,
said handle includes a thread,
said holding device includes a second counter surface and a thread, said second counter surface being designed to cooperate with said second functional surface of said end piece, said holding device and said handle being designed to be connected by said threads engaging, said threads cooperating such that a variation of the engagement of said threads changes a contact force between said functional part and said first functional surface and said second functional surface.

29. The screw driver of claim 27, wherein said holding device is designed to have approximately the shape of an “L” as seen in a semi-cross-section, said L including a first leg and a second leg,
said first leg having an inner side and being designed and arranged to surround a longitudinal axis of said screw driver, said thread of said holding device being arranged at said inner side of said first leg,
said second leg being designed and arranged to extend in a transverse direction with respect to the longitudinal axis of said screw driver, said second counter surface of said holding device being arranged at said second leg.

30. The screw driver of claim 27, wherein said holding device includes a conical inner surface, said conical inner surface constituting said second counter surface of said holding device.

31. The screw driver of claim 27, wherein said holding device includes a conical inner surface and a ball and said functional part includes a channel,
said ball being designed and arranged to contact said conical inner surface,
said ball being pressed towards said channel in a radial inward direction during continued screwing.

32. The screw driver of claim 31, wherein said ball is designed to be guided in said handle in a radial direction.

33. The screw driver of claim 1, wherein said end piece includes a rear part and a front part and said handle includes a screw cap and a threaded portion,
said rear part being designed to be substantially conical and to have a circular cross-section of a diameter,
said front part having a diameter, the diameter of said front part being greater than the diameter of said rear part,
said front part including a tooth arrangement including at least one tooth, said tooth arrangement being designed and arranged to engage said handle,
said end piece being held in position by said screw cap engaging said threaded portion of said handle.

34. The screw driver of claim 1, wherein said end piece has a front portion and a rear portion and said handle has a front portion and includes a screw cap having a face and a threaded portion,
said end piece in the front portion being designed as a cone having a face,
said end piece in the rear portion including a cylindrical tappet,
said screw cap and said threaded portion being located in the front portion of said handle,
said end piece being pressed into said handle by said screw cap when said screw cap is screwed onto said threaded portion of said handle, said face of said screw cap contacting said face of said cone.

35. The screw driver of claim 1, wherein said handle comprises a threaded extension with slots, said extension comprising a front surface being conical, said holding device comprising a screw cap comprising an inner cone in its front portion, said extension being radially compressed with screwing said screw cap with said extension, so that similar to a clamping chuck a frictional engagement between handle and end piece is created.

36. The screw driver of claim 35, wherein said end piece comprises at least one rib that positively engages in circumferential direction in a slot of said extension.

37. The screw driver of claim 1, wherein said holding device comprises a screw cap that is rotatably with respect to a longitudinal axis of said screw driver and supported by said handle, said screw cap having at least one segment protruding in radial and inward direction and engaging with a cavity of said end piece for a positive engagement in said secured position and being disengaged by a rotation of said screw cap from said secured position to said released position.

38. The screw driver of claim 37, wherein said screw cap or said end piece comprises at least one limiting cam being inserted into a cavity of the other of said screw cap and said end piece and being designed to limit the angle of rotation of said screw cap.
